(19) United States
(12) Patent Application Publication
(10) Pub. No.: US 2008/0127345 A1
(43) Pub. Date: May 29, 2008

(54) SMART-CARD CENTRIC SPAM PROTECTION

(75) Inventors: Silke Holtmanns, Klaukkala (FI); Jan Ignatius, Espoo (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/772,052

(22) Filed: Jun. 29, 2007

Related U.S. Application Data
(60) Provisional application No. 60/818,068, filed on Jun. 30, 2006.
(60) Provisional application No. 60/818,440, filed on Jul. 3, 2006.

(51) Int. Cl. G06F 21/00

(52) U.S. Cl. 726/23

(57) ABSTRACT

A system and method for protecting against spam messages. An incoming filtering message system receives an anti-spam policy configuration message and forwards the message to a trusted environment, such as a smart card. The configuration is forwarded to the trusted environment over a secure channel, such as an encrypted tunnel. An anti-spam filter is created based upon the message. Upon receiving a potential spam message at the apparatus, the incoming filtering message system retrieves at least one of the created anti-spam filters and applies the anti-spam filter to parameters of the potential spam message. If after applying the filter, it is determined that the potential spam message is an actual spam message, the actual spam message is either sent to a junk folder and later deleted or immediately deleted. Alternatively, a user of the apparatus may be queried to confirm that the potential spam message is an actual spam message.

### FIELD OF THE INVENTION

The present invention relates generally to the field of spam protection. More specifically, the present invention relates to protecting an apparatus from spam by using a smart card or trusted platform-based anti-spam feature that is at least in part controlled by a service provider operator.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Spamming is generally considered to be the abusive practice of sending unsolicited and/or unauthorized bulk messages, i.e., spam, to various recipients. Spamming is engaged in because it provides an economically viable way of advertising, where advertisements are embedded in or sent with the messages. Although the practice of spamming is a well-known problem in the fixed internet world, where spam is usually seen in the form of emails, the term can also be applicable to abuses in other types of media, i.e., instant messaging spam, web search engine spam, and Usenet newsgroup spam. Spamming in these types of media usually entails sending a deluge of emails and instant messages, flooding a newsgroup with multiple, repetitive posts, and deliberately modifying webpages to direct webpage viewers to another website.

Spamming is undesirable from an internet service provider (ISP) point of view because it annoys customers, it abuses network resources, and ISPs hosting a spammer (many times unknowingly) risk being blacklisted by other ISPs. In addition, ISP customers generally must bear the cost of spamming because ISPs must add extra infrastructure capacity to handle the increase in email traffic, for example, thus adding to the cost of the overall ISP service. Presently, ISPs are struggling to find a solution to efficiently control and limit the spamming problem.

Spamming has also found its way into the realm of mobile communications, most often being directed to the messaging services of a mobile device such as a mobile phone or wireless personal digital assistant (PDA). Mobile spam messages can comprise simple requests to call a certain telephony number. Many users, adhering to mobile phone etiquette, will actually call the certain telephony number in response to the request. Unbeknownst to the user, he or she will have been fraudulently induced to call a premium-rate service, the purpose of which, is to keep the user connected for as long a time as possible in order to garner as much revenue as possible from the call or to initiate a download of malicious software. Other mobile spam, like the email spam discussed above, comprises unsolicited advertisements sent to a mobile phone in the form of messages, such as short message service (SMS) messages and multimedia messaging service (MMS) messages. In the mobile environment spamming is even more of a severe threat because network resources are much more costly and the user may actually have to pay for receiving spam messages.

Mobile anti-spamming measures have traditionally been implemented only on a mobile network level, where certain spam protection mechanisms can be implemented at network elements to prevent spam from reaching end users. Various industry groups such as the Global System for Mobile Communications (GSM) Association (GSMA) Security Group and the 3^{rd} Generation Partnership Project (3GPP) have identified a need to develop countermeasures against SMS and MMS spam at the device level. However, only general recommendations have been purported, where a concrete implementation(s) of interfaces and/or processes has yet to be specified.

FIG. 1 shows a system 10 in which spamming can occur, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile device 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), IP Multimedia Subsystem Services (IMS), Bluetooth, IEEE 802.11, etc. A communication device may communicate using various media including, but not limited to, radio, infrared, laser, cable connection, and the like.

A Universal Integrated Circuit Card (UICC) is a chip card used in mobile terminals in GSM and UMTS networks. The UICC ensures the integrity and security of all kinds of personal data, and it typically holds a few hundred kilobytes. In a GSM network, the UICC contains a subscriber identity module (SIM) application and in a UMTS network it is the USIM application. A UICC may contain several applications, making it possible for the same smart card to give access to both GSM and UMTS networks, and also provide storage of a phone book and other applications.

The UICC smart card consists of a CPU, ROM, RAM, EEPROM and I/O circuits. Since the card slot for receiving the UICC smart card is standardized, a subscriber can easily move their wireless account and phone number from one handset to another. This will also transfer their phone book and text messages. Similarly, in theory, a subscriber can change carriers by inserting a new carrier's UICC card into their existing handset. The use and content of the card can even be protected by use of PIN codes, where one PIN code can be defined to control normal use of the phone, and another code can be set to allow the use of special functions (like limiting outbound telephone calls to a list of numbers).

### SUMMARY OF THE INVENTION

The various embodiments of the present invention comprise a system and method of protecting a mobile apparatus from spam messages. In one embodiment of the present invention, a filtering system or module of a mobile device receives an externally managed and controlled anti-spam configuration profile. The anti-spam configuration profile is passed to a smart card or trusted environment of the mobile device over a secure channel, and is used to create one or more anti-spam filters. When the mobile device receives a message, such as an SMS, MMS message, or other type of message, the filtering system retrieves at least one of the latest anti-spam filters and applies it to the received message. To save bandwidth, the latest anti-spam filter is not downloaded every time a message is received, but is retrieved from a trusted storage, i.e., the smart card or trusted environment/platform. The anti-spam filter data may contain key words, black lists or a statistical analysis filter data. If the message is determined to be spam, the message can be placed into a junk folder or be deleted immediately. Alternatively, a user of the mobile device can be queried as to whether or not the received message is actually spam. In another embodiment of the present invention, an identifier identifying the sender of an SMS, MMS, or other message is first determined. The identifier is compared to a filter or list of identifiers identifying known spamming entities, e.g., a so-called black list. If the identifier of the received message matches the identifier of a known spamming entity, the mobile device transmits an error code in response to the received message that is conventionally sent if the recipient of the message is not known. This prevents a spamming entity from determining whether or not delivery of the spam message has been successful. Therefore, there is no way for the spamming entity to know if a user's mobile device address is “alive” or available to be spammed.

Network elements have very high operational performance requirements, and the introduction of anti-spam mechanisms at the network level slows down the operation of the network and of crucial nodes within the network. It should also be noted that the performance requirements regarding network availability in a mobile communication network are much higher than those of the Internet, since revenue generation for mobile service providers/operators is entirely based on the availability of the network services. The various embodiments of the present invention provide protection from spam at the smart card or trusted environment level, thus allowing networks to run at their optimum levels. This is possible because at least some of the spam prevention performance load is shifted to mobile devices instead of burdening the network. In addition, it is generally easier to implement new features on mobile devices, rather than upgrading an entire network. Mobile devices can be upgraded via configuration messages or just via the natural replacement process. Furthermore, implementing anti-spam protection on removable media such as a smart card, or on and otherwise trusted environment, protection can be provided while a user of a mobile device is, for example, roaming within a network, other than a home network.

These and other features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile device that can be used in the implementation of the present invention;

FIG. 3 is a schematic representation of circuitry of the mobile device of FIG. 2 utilizing various embodiments of the present invention;

FIG. 4 is a network representation of a mobile spamming scenario;

FIG. 5 is a diagram showing the messaging occurring between mobile equipment and a mobile network in one embodiment of the present invention;

FIG. 6 is a diagram showing the messaging occurring between mobile equipment and a mobile network in another embodiment of the present invention; and

FIG. 7 is a flow chart diagram showing the process of handling a potential spam message received at a mobile device.

### DETAILED DESCRIPTION OF THE PREFERRED EMBODIMENTS

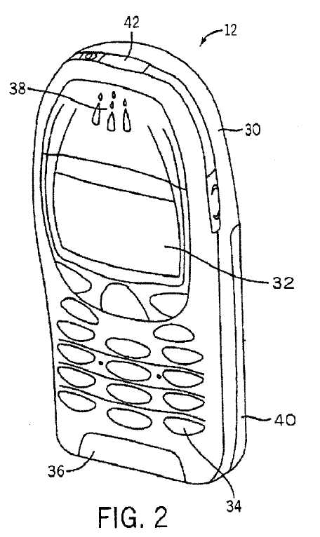

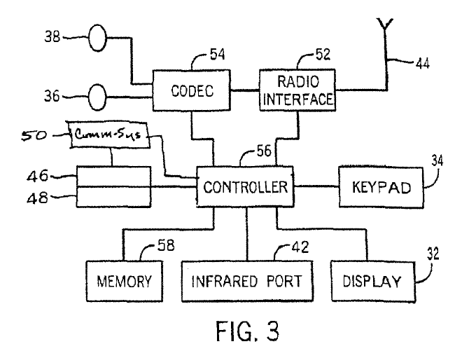

FIGS. 2 and 3 show one representative mobile device 12 within which the present invention may be implemented. It should be understood, however, that the present invention is not intended to be limited to one particular type of mobile device 12 or other electronic device. The mobile device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48 (that may be embedded in the actual card), radio interface circuitry 52, codec circuitry 54, a controller 56 and a memory 58, and a battery/smart card cover 80. Individual circuits and elements are all of a type well known in the art, for example in the Nokia range of mobile devices.

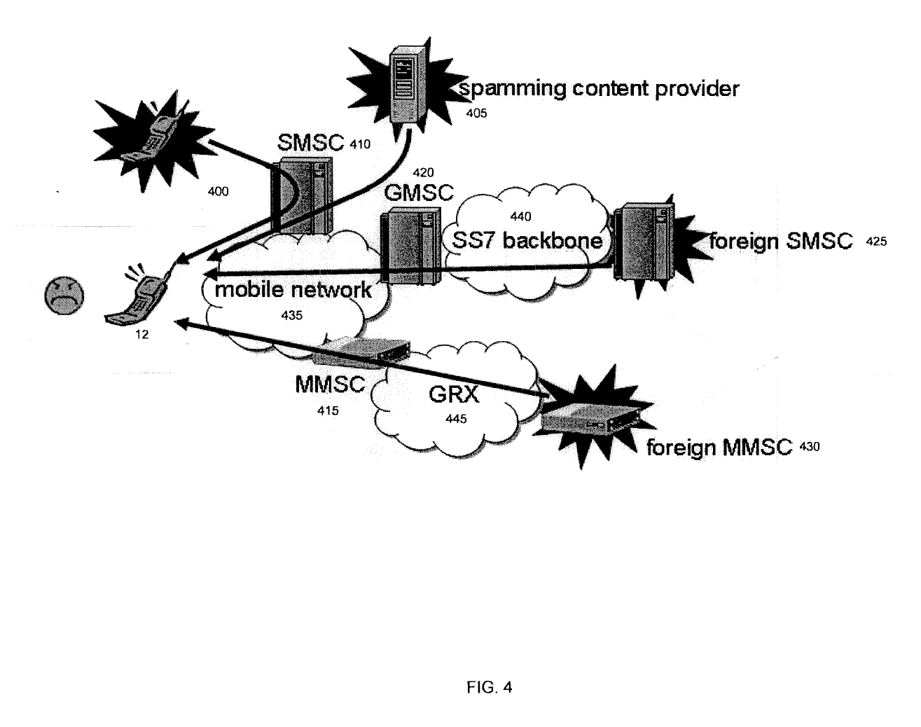

FIG. 4 highlights various scenarios in which a mobile apparatus 12 can receive unsolicited spam messages. It should be noted that spamming can affect the mobile device 12 while it is operating within its own home network and while it is roaming on a foreign network.

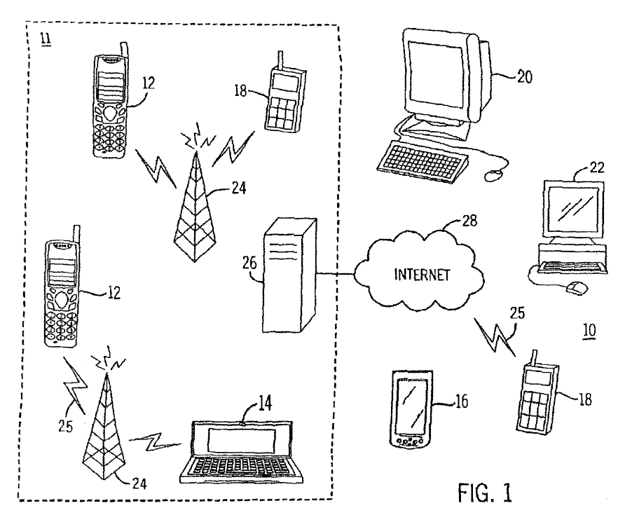

In one scenario, spamming can be conducted by another mobile device 400. The spamming mobile device 400 can send unsolicited SMS messages through a SMS center (SMSC) 410. The SMSC 410 can be operating within a mobile network 435, where the mobile network 435 can be any one of, or any combination of the networks described above with reference to FIG. 1. It should be noted that the spamming mobile device 400 can also utilize other network element(s) and other networks besides those mentioned above, but for illustration purposes, the mobile network 435 can be assumed to be a GSM network having GSM Packet Radio Service (GPRS) capability. A user of the mobile device 12 may be annoyed by the unsolicited SMS messages for various reasons, such as, for example, repeated deliveries of the same SMS message, irrelevant or offensive content embedded within the SMS messages, and the interruption(s) caused by the SMS message delivery. Alternatively, the spamming mobile device 400 can utilize an MMS center (MMSC) 415 to send unsolicited multimedia messages (not shown). In this case, the user of the mobile device 12 may be annoyed, in addition to the aforementioned reasons, because he/she will have to bear the cost of receiving the MMS message. Equally problematic is a scenario where the SMS, MMS, or other type of message contains malicious content that once received, can be downloaded to the mobile device 12. Examples of such malicious content include, but are not limited to viruses, Trojan horse applications, and worms.

There are also multiple scenarios where the user of the mobile device 12 may wish to stop receiving messages from a particular content provider. A content provider can be, but is not limited to, a server, a computer, or some other similar network entity capable of providing content on a network, such as the internet For example, spamming content provider 405 may send unsolicited messages to the user of the mobile device 12, if for example, the user has just acquired a new mobile station integrated services digital network (MSISDN) identifier that was previously assigned to a former customer of the spamming content provider 405. In addition, the spamming content provider 405 may simply ignore requests by the user of the mobile device 12 to stop receiving unsolicited or otherwise undesirable content. In fact, scenarios can arise where the user of the mobile device 12 desires access to, or wishes to receive certain content from the spamming content provider 405, but does not wish to receive other content from the spamming content provider 405 that the user deems to be irrelevant for his or her purposes. The user may simply forgo access to and content from the content provider 405 altogether. This can result in lost revenue for the spamming content provider 405 and an unsatisfied user who has a much higher phone bill then usual because he or she was not in the home network.

Spamming can even occur unintentionally. In an unintentional spamming scenario, the mobile device 12 may receive unsolicited messages because of a software fault or a misconfiguration of a network element, such as a foreign SMSC 425 or a foreign MMSC 430. For example, the foreign SMSC 425 or the foreign MMSC 430 may send multiple copies of the same message to the mobile device 12 because a message delivery confirmation was not received from the mobile device 12. Another potential spamming scenario can occur if either the foreign SMSC 425 or the foreign MMSC 430 does not properly populate the MSISDN of a message sender in the message header. The user of the mobile device 12 could then consider such a message of unknown origis to constitute spam. Yet another scenario involves the foreign SMSC 425 or the foreign MMSC 430 sending spam from a malicious user, after their respective network-based spam protection measures have been compromised.

At present, customers, such as the user of the mobile device 12, have no way to flag offensive messages as spam in order to distinguish such messages from legitimate messages apart from informing the service provider's customer care department. This can amount to a lengthy and involved process. Furthermore, because of the quickness with which spamming entities adapt and circumvent such attempts to block spam, informing the service provider of a specific address from which spam was received is generally ineffective in the long run. For example, a spamming entity can merely register under another address or utilize another mobile device and resume sending spam to the mobile device 12.

Potential anti-spam measures have been proposed, for example, at an application level, where the application level provides various mechanisms by which the user of the mobile device 12 can control and/or altogether avoid spam. One mechanism can be referred to as MSISDN whitelisting, where the mobile device 12 detects a spam message if the MSISDN (or email address in the case of an MMS message) of the spamming mobile device 400 does not correspond to one of a plurality of numbers listed in a “whitelist” specified by the user of the mobile device 12. This is useful, for example, when the user wishes to receive messages from only those messaging entities that are included in his/her whitelist. It should be noted that for a business user of the mobile device 12, the whitelist can comprise an internal corporate telephone directory. Alternatively, MSISDN blacklisting can be effected, where instead of a list of messaging entities permitted to message the user of the mobile device 12, a “blacklist” of messaging entities whose respective messages are to be refused is specified by the user. Upon receiving a message at the mobile device 12, the MSISDN associated with the message is compared to the MSISDNs specified in the black list, and if a match is found, that message is identified to be spam and thereafter rejected. Message filtering based on keywords, statistical data, and/or message type is also a possibility for an anti-spam mechanism. A filter in which certain keywords, statistical data, and/or message types are specified is used to filter incoming messages and to determine spam-probability ratings for the incoming messages. If a message is rated by the filter as sufficiently likely to be spam, or if a message contains, for example, enough keywords specified in the filter, or if the message is of a type specified in the filter, that message is deemed to be spam. It should be noted that the systems and method of managing blacklists and whitelists described herein can be applied to managing data items, beyond those relevant to spam protection, stored on a UICC.

The mobile device 12 can store received messages that are determined to be spam in a specific location, such as a junk message folder. In addition, the junk message folder can be associated with a specified time during which messages are stored therein. This allows the user of the mobile device 12 to peruse the junk message folder in case any messages have been mistakenly stored there as spam. Furthermore, the periodic purging of messages allows the memory of the mobile device 12 to be freed up. The junk message folder can also be connected to a virus scanner, where the messages are put into quarantine, since oftentimes the same keywords are attached to virus messages, to lure the user into opening and executing them. It should be understood that the mobile device 12 can automatically perform the actions discussed above, or the user of the mobile device 12 can be queried each time a potential spam or potential spam-associated MSISDN is detected, as to how the potential spam message or MSISDN should be handled. Upon detecting a potential spam message, the user of the mobile device 12 can specify, for example, that every subsequent message from the MSISDN associated with that message is to be considered very likely to be spam. The user can also receive a single message from a certain MSISDN every pre-determined number of days or hours or other duration of time, and indicate that every subsequent message from the certain MSISDN is to be considered spam.

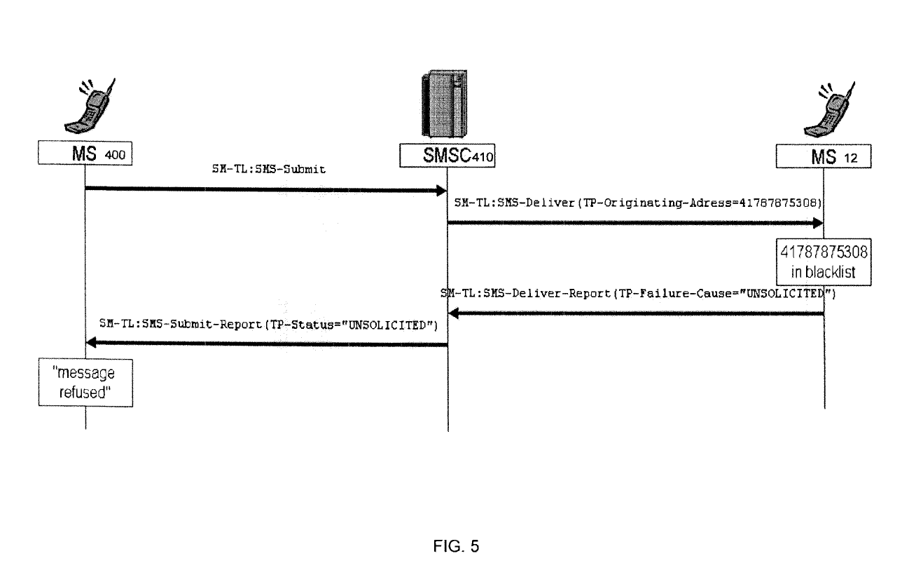

At the network level, certain anti-spam mechanisms can work in conjunction with the application level mechanisms already discussed, where the mobile device-based filtering could, for example, provide a secondary layer of protection. FIG. 5 shows a spamming mobile device 400 transmitting an SMS message by sending an SMS-Submit message to the SMSC 410. The SMSC 410 delivers the SMS message to the mobile device 12 by sending an SMS-Deliver message, indicating the originating mobile (spamming mobile device 400) MSISDN in the transfer protocol (TP)-Originating-Address field. The mobile device 12 flags the SMS message as spam, for example, by detecting that the originating MSISDN is in the MSISDN blacklist of the mobile device 12. The mobile device 12 sends an SMS-Deliver-Report message back to the SMSC 410 specifying a TP-Failure-Cause, indicating that the message was rejected. The SMSC 410 then warns the spamming mobile device 400 that the message was refused by the mobile device 12 by submitting an SMS-Submit-Report message to the spamming mobile device 400 indicating that the SMS message is unsolicited in the TP-Status field.

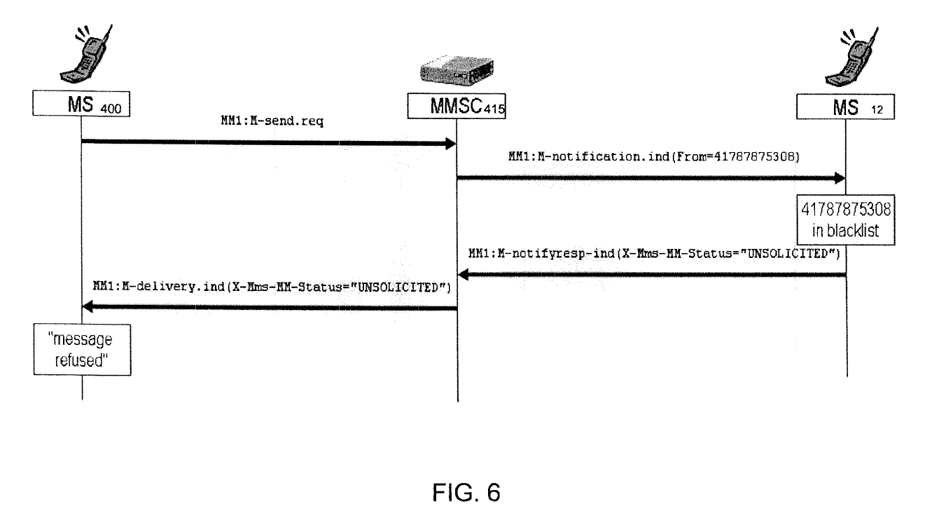

In FIG. 6, the spamming mobile device 400 submits an MMS message by sending an M-send.req message to the MMSC 415. The MMSC 415 sends an M-notification.ind message indicating the mobile device 400 MSISDN in the From field. The mobile device 12 flags the MMS message as spam, for example by detecting that the MSISDN of the spamming mobile device 400 is in the MSISDN blacklist of the mobile device 12. The mobile device 12 sends an MMS-notifyresp.ind message back to the MMSC 415 specifying an X-Mms-Status message indicating that the MMS message was unsolicited. The MMSC 415 then warns the user of the spamming mobile device 400 that the message was refused by the use of the mobile device 12 by sending an M-delivery.ind message indicating in the X-Mms-MM-Status field that the MMS message is unsolicited.

In various embodiments of the present invention, the user of the mobile device 12 can have the ability to transfer the MSISDN blacklist, whitelist, and other anti-spam parameters from one mobile device to another. For security reasons, the user's data needs to be protected on the mobile device 12 from being stolen or modified. Furthermore, a service provider operator that provides communication services to the mobile device 12 needs to be able to manage a list of MSISDNs and email addresses, in the case of MMS messages, that the user of the mobile device 12 cannot blacklist. Such MSISDNs and email addresses can include, but are not limited to those associated with the service provider that are used to transmit legitimate information or updates to the mobile device 12. Such a list can be stored on the UICC 46 of the mobile device 12, and can be updatable over the air in one particular embodiment.

The introduction of failure codes for flagging spam messages can provide visibility at the service provider operator level for messages that customers do not want to receive. The monitoring of those failure codes will also allow the introduction of advanced spam detection in message centers, such as the SMSCs 410 and 425, the MMSCs 415 and 430, and/or service provider communication networks, such as the mobile network 435, the public switched telephone network (PSTN) 440, having utilizing a System Signaling 7 (SS7) backbone, and the GPRS Roaming Exchange (GRX) network.

In order to execute the anti-spam mechanisms discussed above, various embodiments of the present invention utilize the UICC 46 to host an anti-spam profile, as suggested above. The anti-spam profile can be managed and controlled, at least in part, by a service provider operator, and enforcement of the anti-spam policy defined, at least in part, by the anti-spam profile is handled by filtering system or module that filters incoming and/or stored SMS and MMS messages. The filtering system and the anti-spam policy storage are regarded as trustworthy by an external controller, such as the service provider. FIG. 3 shows the mobile device 12 having an incoming message filtering system/module (Comm-Sys) 50 communicatively connected to the UICC 46 (or trusted platform) using a secure channel. For example, the UICC 46 and the Comm-Sys 50 can communicate over an encrypted tunnel. It is assumed that the mobile terminal 12 also has some type of messaging application with a user interface (not shown).

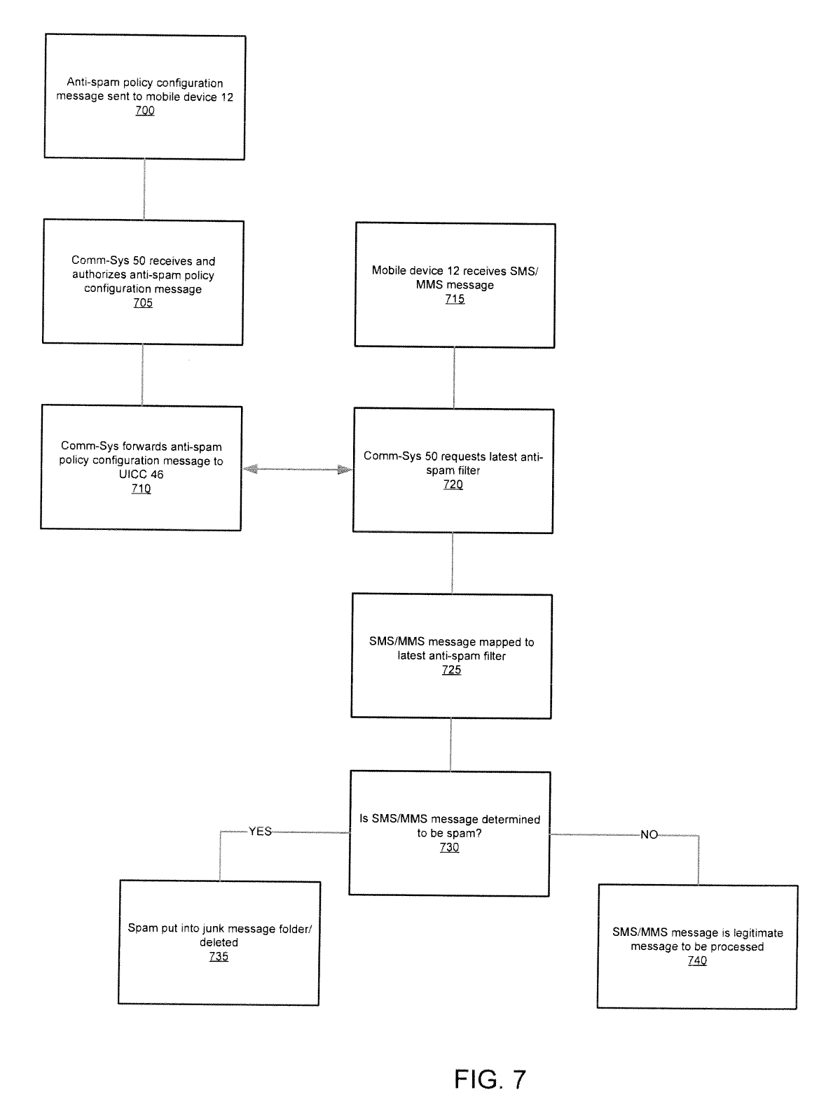

FIG. 7 shows a flow chart diagramming the process by which various embodiments of the present invention enable anti-spam policy enforcement. At 700, a communication network, such as the mobile network 435, sends an anti-spam policy configuration message to the mobile device 12 via SMS, wireless application protocol (WAP) Push command, email, or by an explicit device pull-request triggered by the user or the mobile device 12, e.g., when the mobile device 12 is in its home-network. Upon receipt of the anti-spam policy configuration message, the Comm-Sys 50 gets the policy message and authorizes it at 705. At 710, the Comm-Sys 50 forwards the policy message to the UICC 46. It should be noted that the anti-spam policy configuration message is used to create an anti-spam filter. When an SMS or MMS message is received at the mobile device 12 at 715, the Comm-Sys 50 requests the latest anti-spam filter from the UICC 46 at 720 and maps the received SMS/MMS message against the anti-spam filter at 725. As discussed above, the anti-spam filter can comprise an MSISDN or email address blacklist, whitelist, keyword or message type filter, etc. It should also be noted that another identifier besides an MSISDN or email address can be used to identify a message sender, if appropriate. If the SMS/MMS message is determined to be spam at 730, the message is put into a junk message folder and/or deleted at 735. In addition, a message can be sent to the mobile network 435, informing it not to bill the spam message to the user of the mobile device 12. Also, as discussed above, if desired, the user of the mobile device 12 can be queried to confirm that the received SMS/MMS message is actually spam, and how to dispose of, or otherwise process the SMS/MMS message. The user of the mobile device 12 can also update the anti-spam filter with the MSISDN or email address associated with the received SMS/MMS message. If the SMS/MMS message is determined to be a legitimate message, it is processed accordingly at 540, e.g., the message is displayed on display 32 of the mobile device 12.

In another embodiment of the present invention, the mobile device 12 is first notified of the MSISDN, username, public IMS address, real name, and/or email address, etc. of the SMS/MMS message sender. If any single one of, or combination of the above identifiers matches any single one of, or combination of identifiers stored in the anti-spam filter of the mobile device 12, the mobile device 12 responds with an error code. This prevents any further interaction with the SMS/MMS message, as well as reduces the amount of data transmitted over the air.

In yet another embodiment of the present invention, the UICC 46 can be substituted with a mass memory as long as the memory comprises a trusted environment. Moreover, the processes described above can be applied to nearly any externally controlled configuration message, where modifying and/or transmitting the message is required.

Unlike merely downloading or creating an anti-spam profile to or on a personal computer (PC), as is conventionally done when dealing with fixed internet spam, the anti-spam profile is stored to a trusted environment, such as a UICC or other trusted hardware. With the example given regarding the PC, the anti-spam profile does not become a part of the open PC platform or the operating system running on the PC that is accessible by all programs that run on the PC. Instead, it is merely tied to an email program or is configured as an extension thereto. Therefore, the PC does not have a trusted environment or hardware box that can still be externally controlled. Also, the in the PC environment there is no external controller of the trusted entity. In addition, with the PC example give above, in order to secure communications between the PC/email application software and an anti-spam profile center from where an anti-spam profile can be downloaded, a public key infrastructure or shared secret security procedure must be utilized. Furthermore, providing anti-spam protection at the network level limits when and where a user of a mobile device can receive protection. For example, if the user of the mobile device roams into a network other than his or her home network, the user may not receive the same anti-spam protection provided in the home network or may not receive anti-spam protection at all. Also, the network protection might also reach its limits, if the network load becomes too high and the filtering on network level has to be restricted in order to continue offering service.

It should be noted that although spam protection processes have been described herein, various embodiments of the present invention can be applied to other types of processes, e.g., managing data items such as the storage of generic bootstrapping architecture (GBA) network application function (NAF) keys in a UICC. That is, the process(es)/policies described above with respect to managing blacklist and whitelist entries can be utilized to manage the GBA NAF keys, email addresses, hashes, etc.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the word “module,” as used herein and in the claims, is intended to encompass implementations using one or more lines of software code, and/or hardware implementations, and/or equipment for receiving manual inputs. A trusted module is an entity, that is protected against unsolicited execution of code that is not approved either by the user or the network controller.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of protecting a device against spam, comprising:
receiving an externally controllable and manageable configuration message; and
forwarding the externally controllable and manageable configuration message to a trusted environment over a secure channel.

2. The method of claim 1, wherein at least one filer is created from the externally controllable and manageable configuration message and stored; and
upon a need to identify a potential spam message, retrieving a latest one of the at least one filter from the trusted environment;
applying the latest one of the at least one filter to at least one parameter of the potential spam message; and
determining whether the potential spam message is an actual spam message as a result of the application of the at least one filter.

3. The method of claim 1, wherein the externally controllable and manageable configuration message is an anti-spam profile.

4. The method of claim 3, wherein the anti-spam profile is controlled and managed, at least in part, by a service provider operator.

5. The method of claim 3, wherein the anti-spam profile is controlled and managed, at least in part, by the user.

6. The method of claim 1, wherein the trusted environment comprises a smart card.

7. The method of claim 6, wherein the smart card comprises a trusted integrated circuit card.

8. The method of claim 1, wherein the trusted environment comprises a trusted platform.

9. The method of claim 1, wherein the secure channel comprises an encrypted tunnel.

10. The method of claim 2, wherein the at least one filter comprises at least one list selected from a group consisting of a list of mobile station identifiers, messages from which are to be rejected, a list of mobile station identifiers, messages from which are to be allowed, a list of keywords, wherein a message containing at least one of the keywords is be to rejected, and a list of message types, wherein a message corresponding to any of the listed messages is to be rejected.

11. The method of claim 2, further comprising, assigning a spam-probability rating to the potential spam message based upon the application of the latest one of the at least one filter.

12. The method of claim 2, further comprising, upon determining that the potential spam message is an actual spam message, sending the actual spam message to a junk folder.

13. The method of claim 2, further comprising, upon determining that the potential spam message is an actual spam message, deleting the actual spam message.

14. The method of claim 2, further comprising, upon determining that the potential spam message is an actual spam message, querying a user of the device to confirm that the potential spam message is an actual spam message.

15. The method of claim 14, further comprising updating an anti-spam profile based upon a user response to the querying of the user of the device to confirm that the potential spam message is an actual spam message.

16. The method of claim 2, further comprising, upon determining that the potential spam message is an actual spam message, informing a billing network not to bill the device.

17. The method of claim 2, further comprising, upon determining that the potential spam message is an actual spam message, informing a network entity to update its network-based spam filtering.

18. The method of claim 17, further comprising informing a network entity to update its network-based spam filtering according to a predetermined schedule.

19. The method of claim 2, wherein the application of the latest one of the at least one filter comprises notifying a user of the device of at least one identifying parameter of the potential spam message.

20. The method of claim 2, further comprising, upon determining that the potential spam message is an actual spam message, instructing the device to respond with an error code message.

21. A computer program product, embodied on a computer-readable medium, comprising:
computer code for receiving an externally controllable and manageable configuration message; and
computer code for forwarding the externally controllable and manageable configuration message to a trusted environment.

22. The computer program product of claim 21, wherein at least one filter is created from the externally controllable and manageable configuration message and stored, the computer program product further comprising:
computer code for upon receipt of a potential spam message, retrieving a latest one of the at least one filter from the trusted environment;
computer code for applying the latest one of the at least one filter to at least one parameter of the potential spam message; and
computer code for determining whether the potential spam message is as an actual spam message as a result of the application of the at least one filter.

23. The computer program product of claim 21, wherein the trusted environment comprises a smart card.

24. The computer program product of claim 23, wherein the smart card comprises a trusted integrated circuit card.

25. The computer program product of claim 21, wherein the trusted environment comprises a trusted platform.

26. The computer program product of claim 21, wherein the secure channel comprises an encrypted tunnel.

27. An apparatus comprising:
a processor; and
a message filtering module communicatively connected to the processor and a trusted environment, and including:
computer code for receiving an externally controllable and manageable configuration message; and
computer code for forwarding the externally controllable and manageable configuration message to a trusted environment over a secure channel.

28. The apparatus of claim 27, wherein at least one filter is created from the externally controllable and manageable configuration message and stored, the apparatus further comprising:
computer code for, upon receipt of a potential spam message, retrieving a latest one of the at least one filter from the trusted environment;
computer code for applying the latest one of the at least one filter to at least one parameter of the potential spam message; and
computer code for determining whether the potential spam message is as an actual spam message as a result of the application of the at least one filter.

29. The apparatus of claim 27, wherein the externally controllable and manageable configuration message is an anti-spam profile.

30. The apparatus of claim 29, wherein the anti-spam profile is controlled and managed, at least in part, by a service provider operator.

31. The apparatus of claim 29, wherein the anti-spam profile is controlled and managed, at least in part, by the user.

32. The apparatus of claim 27, wherein the trusted environment comprises a smart card.

33. The apparatus of claim 32, where the smart card comprises a trusted integrated circuit card.

34. The apparatus of claim 27, wherein the trusted environment comprises a trusted platform.

35. The apparatus of claim 27, wherein the secure channel comprises an encrypted tunnel.

36. The apparatus of claim 28, wherein the at least one filter comprises at least one list selected from a group consisting of a list of mobile station identifiers, messages from which are to be rejected, a list of mobile station identifiers, messages from which are to be allowed, a list of keywords, wherein a message containing at least one of the keywords is be to rejected, and a list of message types, wherein a message corresponding to any of the listed messages is to be rejected.

37. The apparatus of claim 28, further comprising, assigning a spam-probability rating to the potential spam message based upon the application of the latest one of the at least one filter.

38. The apparatus of claim 28, wherein the message filtering module further comprises computer code for, upon determining that the potential spam message is an actual spam message, sending the actual spam message to a junk folder.

39. The apparatus of claim 28, wherein the message filtering module further comprises computer code for, upon determining that the potential spam message is an actual spam message, deleting the actual spam message.

40. The apparatus of claim 28, wherein the message filtering module further comprises computer code for, upon determining that the potential spam message is an actual spam message, querying a user of the device to confirm that the potential spam message is an actual spam message.

41. The apparatus of claim 40, wherein the message filtering module further comprises computer code for, updating the anti-spam filter profile based upon a user response to the querying of the user of the device to confirm that the potential spam message is an actual spam message.

42. The apparatus of claim 28, wherein the message filtering module further comprises computer code for, upon determining that the potential spam message is an actual spam message, informing a billing network not to bill the device.

43. The apparatus of claim 28, wherein the message filtering module further comprises computer code for, upon determining that the potential spam message is an actual spam message, informing a network entity to update its network-based spam filtering.

44. The apparatus of claim 28, wherein the message filtering module further comprises computer code for, informing a network entity to update its network-based spam filtering according to a predetermined schedule.

45. The apparatus of claim 28, wherein the application of the latest one of the at least one filter comprises notifying a user of the device of at least one identifying parameter of the potential spam message.

46. The apparatus of claim 28, wherein the message filtering module further comprises computer code for, upon determining that the potential spam message is an actual spam message, instructing the device to respond with an error code message.

47. An externally controllable and manageable configuration message created by a service provider operator, wherein:
a message filtering module receives the externally controllable and manageable configuration message from a network;
a trusted environment communicatively connected to the message filtering module receives the externally controllable and manageable configuration message over a secure channel, wherein at least one filter is created from the externally controllable and manageable configuration message and stored; and
upon receipt of a potential spam message, the message filtering module retrieves a latest one of the at least one filter from the trusted environment and applies the latest one of the at least one filter to at least one parameter of the potential spam message, and determines whether the potential spam message is an actual spam message as a result of the application of the at least one filter.
